(19) United States
(12) Patent Application Publication
(10) Pub. No.: US 2024/0003781 A1
(43) Pub. Date: Jan. 4, 2024

(54) MACHINE TOOL AND DIAGNOSTIC METHOD

(71) Applicant: FANUC CORPORATION, Minamitsuru-gun, Yamanashi (JP)

(72) Inventor: Koki KAMETA, Minamitsuru-gun, Yamanashi-ken (JP)

(73) Assignee: FANUC CORPORATION, Minamitsuru-gun, Yamanashi (JP)

(21) Appl. No.: 18/037,950

(22) PCT Filed: Nov. 24, 2021
(86) PCT No.: PCT/JP2021/042890

§ 371 Date: May 19, 2023

(30) Foreign Application Priority Data
Nov. 27, 2020 (JP) 2020-196713

(51) Int. Cl. G01M 99/00

(52) U.S. Cl. CPC G01M 99/005

(57) ABSTRACT

In a machine tool according to an embodiment of the present invention, a first motor and a second motor are controlled to drive a first movable part and a second movable part by a prescribed drive operation in each of a plurality of orientation positions. In the machine tool, a frequency characteristic of at least one of the first motor and the second motor is acquired that includes the times that the first movable part and the second movable part are positioned in each of the plurality of orientation positions, each of the frequency characteristics is compared with a corresponding standard frequency characteristic, and the presence of a malfunction in the machine tool is determined on the basis of the comparison result.

### TECHNICAL FIELD

The present invention relates to a machine tool and a diagnostic method.

### BACKGROUND ART

In a machine tool, there are cases in which an abnormality is diagnosed in a feed shaft of the machine tool. In JP 2018-017689 A, an abnormality determination method is disclosed for determining an abnormality in one feed axis. In such an abnormality determination method, frequency characteristics of an NC (numerically controlled) feed shaft when the feed shaft is in a normal state are used as reference values. The reference values are compared with frequency characteristics at the time of measurement.

### SUMMARY OF THE INVENTION

In general, however, in machine tools, there are a plurality of feed axes, and cases occur in which the frequency characteristics change when the relative positions between the components fed by each of the plurality of the feed axes are changed. For this reason, there is a concern that simply diagnosing an abnormality in a single one of the feed axes may result in inferior reliability.

Thus, the present invention has the object of providing a machine tool and a diagnostic method, which are capable of improving the reliability of an abnormality diagnosis.

A first aspect of the present invention is characterized by a machine tool comprising a first movable member, and a second movable member that is different from the first movable member, the machine tool comprising:
a motor control unit configured to control a first motor configured to drive the first movable member and a second motor configured to drive the second movable member, in a manner so that the first movable member and the second movable member move under predetermined movement conditions to each of a plurality of attitude positions determined by position information of the first movable member and position information of the second movable member;
an acquisition unit configured to acquire frequency characteristics of at least one of the first motor and the second motor including times when the first movable member and the second movable member are positioned in each of the plurality of attitude positions;
a storage unit configured to store reference frequency characteristics with respect to each of the frequency characteristics acquired by the acquisition unit; and
a determination unit configured to compare each of the frequency characteristics acquired by the acquisition unit with corresponding reference frequency characteristics, and to determine whether or not an abnormality has occurred in the machine tool based on a result of the comparison.

A second aspect of the present invention is characterized by a diagnostic method for diagnosing an abnormality in a machine tool comprising a first movable member and a second movable member that is different from the first movable member, the diagnostic method comprising:
a motor control step of controlling a first motor configured to drive the first movable member and a second motor configured to drive the second movable member, in a manner so that the first movable member and the second movable member move under predetermined movement conditions to each of a plurality of attitude positions determined by position information of the first movable member and position information of the second movable member;
an acquisition step of acquiring frequency characteristics of at least one of the first motor and the second motor including at times when the first movable member and the second movable member are positioned in each of the plurality of attitude positions; and
a determination step of comparing each of the frequency characteristics acquired in the acquisition step with corresponding reference frequency characteristics, and determining whether or not an abnormality has occurred in the machine tool based on a result of the comparison.

According to the present invention, the presence or absence of an abnormality in the machine tool can be determined based on a change in the frequency characteristics in accordance with the relative positions of the first movable member and the second movable member, and thus, as compared with a case of simply capturing the frequency characteristics of a single feed axis, an improvement in the reliability of diagnosing an abnormality can be realized.

### BRIEF DESCRIPTION OF DRAWINGS

FIG. 1 is a schematic diagram showing a configuration of a machine tool according to an embodiment;

FIG. 2 is a schematic diagram showing a configuration of a control device;

FIG. 3 is a flowchart showing a process flow of a diagnostic process; and

FIG. 4 is a schematic diagram showing a configuration of a machine tool according to an Exemplary Modification 1.

### DETAILED DESCRIPTION OF THE INVENTION

### Embodiment

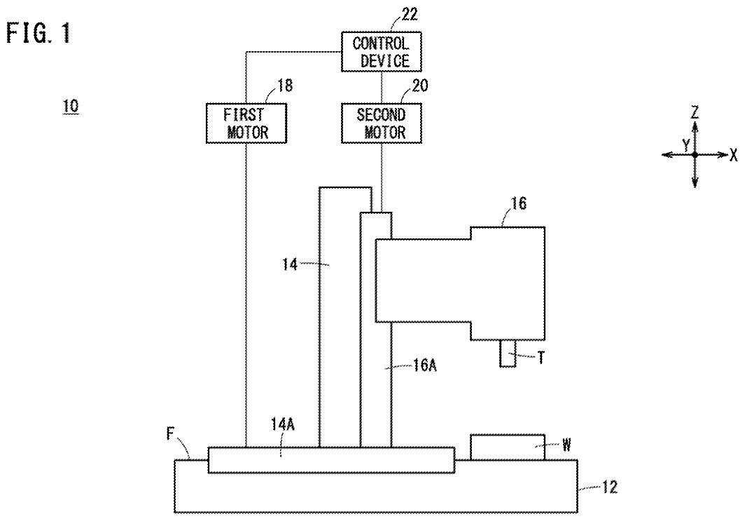

With reference to FIG. 1, a description will be given concerning a machine tool 10 according to a present embodiment. The machine tool 10 uses a tool T and thereby machines a workpiece W. The machine tool 10 includes a platform 12, a first movable member 14, a second movable member 16, a first motor 18, a second motor 20, and a control device 22.

The platform 12 serves as a foundation for the machine tool 10. A workpiece W is fixed at a predetermined site of a mounting surface F of the platform 12.

The first movable member 14 is not particularly limited except that it is capable of moving along one direction. According to the present embodiment, the first movable member 14 is a support base on which there is mounted a spindle member that supports a tool T in a rotatable manner. The first movable member 14 is disposed on the platform 12 via a power transmission mechanism 14A. The power transmission mechanism 14A transmits a driving force of the first motor 18 to the first movable member 14. The power transmission mechanism 14A may convert a driving force (a rotational force) of the first motor 18 into linear motion, and transmit the linear motion to the first movable member 14. Further, the power transmission mechanism 14A may transmit a driving force (a thrust force) of the first motor 18 to the first movable member 14 as it is. By the first motor 18 being driven, the first movable member 14 moves relatively in an X-direction (first direction) with respect to the platform 12. The first motor 18 is a motor that drives the first movable member 14. Moreover, it should be noted that the first motor 18 may be a linear motor.

The second movable member 16 is not particularly limited, except that it is capable of moving in a direction that differs from the direction in which the first movable member 14 moves. According to the present embodiment, the second movable member 16 is a spindle member. The spindle member includes a spindle on which a tool T is mounted, a housing into which the spindle is inserted, and a bearing that supports the spindle in a rotatable manner with respect to the housing. The second movable member 16 is mounted on the first movable member 14 via a power transmission mechanism 16A. The power transmission mechanism 16A transmits a driving force of the second motor 20 to the second movable member 16. The power transmission mechanism 16A may convert a driving force (a rotational force) of the second motor 20 into linear motion, and transmit the linear motion to the second movable member 16. Further, the power transmission mechanism 16A may transmit a driving force (a thrust force) of the second motor 20 to the second movable member 16 as it is. By the second motor 20 being driven, the second movable member 16 moves relatively in a Z-direction (second direction) with respect to the first movable member 14. The second motor 20 is a motor that drives the second movable member 16. Moreover, it should be noted that the second motor 20 may be a linear motor.

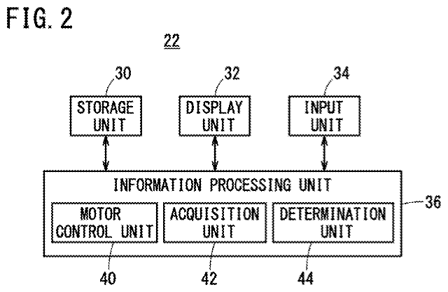

The control device 22 controls the first motor 18 and the second motor 20. With reference to FIG. 2, a description will be given concerning the control device 22. The control device 22 includes a storage unit 30, a display unit 32, an input unit 34, and an information processing unit 36.

The storage unit 30 serves to store information. The storage unit 30 may be constituted by a volatile memory such as a RAM or the like, and a non-volatile memory such as a ROM, a flash memory, a hard disk, or the like. The display unit 32 serves to display information. The display unit 32 may be constituted by a liquid crystal display, a plasma display, a CRT display, or the like. The input unit 34 serves to input information. The input unit 34 may be constituted by a mouse, a keyboard, a touch panel, or the like.

The information processing unit 36 is equipped with a processor such as a CPU, an MPU, or the like. The information processing unit 36 includes a motor control unit 40, an acquisition unit 42, and a determination unit 44. The motor control unit 40, the acquisition unit 42, and the determination unit 44 may be realized by the information processing unit 36 processing a program that is stored in the storage unit 30. Further, at least one of the motor control unit 40, the acquisition unit 42, and the determination unit 44 may be realized by an integrated circuit such as an ASIC, an FPGA, or the like. Further, at least one of the motor control unit 40, the acquisition unit 42, and the determination unit 44 may be constituted by an electronic circuit including a discrete device.

The motor control unit 40 serves to control the first motor 18 and the second motor 20, in a manner so that the first movable member 14 and the second movable member 16 move under predetermined movement conditions to each of a plurality of attitude positions. Each of the plurality of attitude positions is a position determined by the position information of the first movable member 14 and the position information of the second movable member 16. The position information may include machine coordinates (X coordinates, Z coordinates). The position information is stored in the storage unit 30. The movement conditions may include a movement speed and a movement direction. Condition information indicating the movement conditions is stored in the storage unit 30.

In this instance, while citing a specific example, a description will be given concerning the attitude positions and the movement speed. It is assumed that an attitude position “A” is defined by position information “A1” of the first movable member 14 and position information “A2” of the second movable member 16. It is assumed that an attitude position “B” is defined by position information “B1” of the first movable member 14 and position information “B2” of the second movable member 16. In the case of such an assumption, the movement conditions, for example, include a movement speed “X” when moving from the attitude position “A” to the attitude position “B”, and a movement speed “Y” when moving from the attitude position “B” to the attitude position “A”.

The movement speed “X” and the movement speed “Y” may be the same or may be different from each other. Further, the movement speed “X” or the movement speed “Y” at which the first movable member 14 moves, and the movement speed “X” or the movement speed “Y” at which the second movable member 16 moves may be the same or may be different from each other.

Further, the movement conditions may be specified in a manner so that the first movable member 14 and the second movable member 16 move from the attitude position “A” to the attitude position “B”, are temporarily stopped at the attitude position “B”, and then move from the attitude position “B” to the attitude position “A”. On the other hand, the movement conditions may be specified in a manner so that the first movable member 14 and the second movable member 16 move from the attitude position “A” to the attitude position “B” without temporarily stopping at the attitude position “B”, and then move from the attitude position “B” to the attitude position “A”. Further, the number of attitude positions is not limited to being two, and there may be three or more of such positions. Further, the movement conditions are not limited to a case in which the first movable member 14 and the second movable member 16 are moved in a round trip between the attitude position “A” and the attitude position “B”. For example, the movement conditions may be specified in a manner so that the first movable member 14 and the second movable member 16 are moved from the attitude position “A” while passing through the attitude position “B”, and then are moved to an attitude position “C”.

The acquisition unit 42 acquires at least one of a frequency characteristic of the first motor 18 and a frequency characteristic of the second motor 20, including times when the first movable member 14 and the second movable member 16 are positioned in each of the plurality of attitude positions.

The acquisition unit 42 may acquire the frequency characteristic of the first motor 18 and the frequency characteristic of the second motor 20 that are driving the first movable member 14 and the second movable member 16, at times when the first movable member 14 and the second movable member 16 are moving forward and rearward including the attitude positions. In the case of being acquired in this manner, the frequency characteristics can be acquired with vibrational components caused due to backlash being reduced. Further, it is possible to acquire the frequency characteristics including frictional components at times when the first movable member 14 and the second movable member 16 are moving.

The acquisition unit 42 may acquire the frequency characteristic of a motor (the first motor 18 or the second motor 20) that is driving one of the first movable member 14 and the second movable member 16, at times when one of the first movable member 14 and the second movable member 16 is moving forward and rearward including the attitude positions. At that time, the acquisition unit 42 may or may not acquire the frequency characteristic of the motor (the second motor 20 or the first motor 18) that drives the other one of the first movable member 14 and the second movable member 16. Moreover, in the case of acquiring the frequency characteristic of the motor that drives the other one of the first movable member 14 and the second movable member 16, the acquisition unit 42 acquires the frequency characteristic of the motor at times when the other one of the first movable member 14 and the second movable member 16 stays still at the attitude positions.

Further, the acquisition unit 42 may acquire the frequency characteristic of the first motor 18 and the frequency characteristic of the second motor 20, at times when the first movable member 14 and the second movable member 16 stay still at the attitude positions.

A well known method is adopted as the acquisition method by which the acquisition unit 42 acquires the frequency characteristics. For example, an acquisition method may be adopted of acquiring the frequency characteristics by sweeping the frequency characteristics while superimposing a sinusoidal disturbance signal on a command value of each of respective loops, and measuring responses with respect to the superimposed disturbance. Further, an acquisition method may also be adopted of acquiring the frequency characteristics by superimposing white noise on a command value of each of the respective loops, and measuring responses with respect to the superimposed white noise.

After having acquired the frequency characteristics, the acquisition unit 42 accumulates and stores the acquired frequency characteristics in the storage unit 30. The acquisition unit 42 may cause the display unit 32 to display the frequency characteristics that are accumulated and stored in the storage unit 30. Consequently, the operator is made capable of grasping a past diagnostic state of the machine tool 10.

Reference frequency characteristics are stored in advance in the storage unit 30 for each of the frequency characteristics acquired by the acquisition unit 42. The reference frequency characteristics may be the frequency characteristics of the first motor 18 and the frequency characteristics of the second motor 20 at times when the motors are positioned in each of the plurality of attitude positions under the predetermined movement conditions, measured at a time when the machine tool 10 is assembled or the like. Further, the reference frequency characteristics may be the frequency characteristics of the first motor 18 and the frequency characteristics of the second motor 20 at times when the motors are positioned in each of the plurality of attitude positions under the predetermined movement conditions, calculated using a simulator.

The acquisition unit 42 may store as the reference frequency characteristics in the storage unit 30 at least one of the plurality of the acquired frequency characteristics. For example, the acquisition unit 42 causes the display unit 32 to display the acquired frequency characteristics. In the case that the operator has determined that the frequency characteristics displayed on the display unit 32 may be used as a reference, the operator uses the input unit 34, and thereby executes a designating operation that designates the acquired frequency characteristics as the reference. The acquisition unit 42 stores the designated reference frequency characteristics as the reference frequency characteristics in the storage unit 30. In accordance with this feature, from among the frequency characteristics that are actually acquired, ones that are suitable as a reference can be stored as the reference frequency characteristics. Moreover, it should be noted that, in the case that the reference frequency characteristics corresponding to the designated frequency characteristics are already stored in the storage unit 30, the acquisition unit 42 deletes those reference frequency characteristics.

The determination unit 44 compares the plurality of frequency characteristics acquired by the acquisition unit 42 with the corresponding reference frequency characteristics, and on the basis of the comparison result, thereby determines the presence or absence of an abnormality in the machine tool 10.

More specifically, in the case that a comparison result is obtained in which not one of the plurality of frequency characteristics acquired by the acquisition unit 42 exhibits a characteristic difference from the corresponding frequency characteristics of greater than or equal to the predetermined threshold value, the determination unit 44 determines that there is not an abnormality in the machine tool 10. Moreover, as the characteristic difference, there may be cited, for example, an average value of the differences for each of the frequencies between the frequency characteristics and the reference frequency characteristics.

Conversely, in the case that a comparison result is obtained in which one or more from among the plurality of frequency characteristics acquired by the acquisition unit 42 exhibits a characteristic difference from the corresponding frequency characteristics of greater than or equal to the predetermined threshold value, the determination unit 44 determines that there is an abnormality in the machine tool 10.

In this manner, in the determination unit 44, it is possible to determine the presence or absence of an abnormality in the machine tool 10, based on changes in the frequency characteristics in accordance with the relative positions of the first movable member 14 and the second movable member 16. Accordingly, as compared to the case of simply capturing the frequency characteristics of a single feed axis, an improvement in the reliability of diagnosing an abnormality can be realized.

In the case it is determined that there is an abnormality in the machine tool 10, then by driving a notification unit such as the display unit 32 or a speaker or the like, the determination unit 44 issues a notification that there is the possibility of an abnormality occurring in the machine tool 10. In the case that the notification unit is the display unit 32, the determination unit 44 may cause there to be displayed on the display unit 32 that there is a possibility of an abnormality in the machine tool 10. In addition to the foregoing, the determination unit 44 may cause there to be displayed on the display unit 32 the frequency characteristics for which the characteristic differences thereof from the reference frequency characteristics is greater than or equal to the predetermined threshold value.

Moreover, in the case that an abnormality is determined to exist in the machine tool 10, the determination unit 44 may estimate a location having the possibility of an abnormality occurring, based on the frequency characteristics whose difference from the reference frequency characteristics has become greater than or equal to the predetermined threshold value. For example, the acquisition unit 42 estimates the attitude position that was a starting point when the frequency characteristics were obtained whose difference from the reference frequency characteristics has become greater than or equal to the predetermined threshold value, as being a location having the possibility of an abnormality occurring. In accordance with this feature, the abnormality in the machine tool 10 can be captured in detail. Moreover, in the case that the determination unit 44 has estimated a location having the possibility of an abnormality occurring, the determination unit 44 may display on the display unit 32 the location having the estimated possibility of the abnormality occurring. Consequently, it is possible for the operator to grasp where the abnormality in the machine tool 10 is occurring.

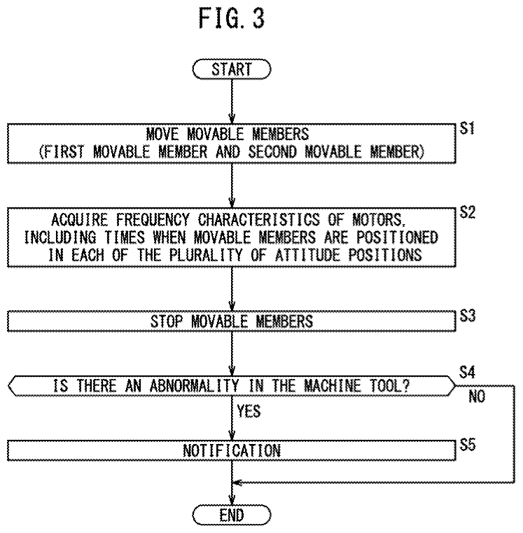

Next, in relation to a diagnostic method for diagnosing an abnormality in the machine tool 10, with reference to FIG. 3, a process flow of a diagnostic process of the information processing unit 36 will be described.

In step S1, the motor control unit 40 starts controlling the first motor 18 and the second motor 20, and causes the first movable member 14 and the second movable member 16 to move to each of the plurality of attitude positions under the predetermined movement conditions. When the control of the first motor 18 and the second motor 20 is started, the diagnostic process transitions to step S2.

In step S2, the acquisition unit 42 acquires the frequency characteristic of the first motor 18 and the frequency characteristic of the second motor 20, including times when the first movable member 14 and the second movable member 16 are positioned in each of the plurality of attitude positions. When each of the frequency characteristics are acquired, the diagnostic process transitions to step S3.

In step S3, the motor control unit 40 controls the first motor 18 and the second motor 20, and thereby causes the first movable member 14 and the second movable member 16 to stop. When the first movable member 14 and the second movable member 16 come to a stop, the diagnostic process transitions to step S4.

In step S4, the determination unit 44 compares each of the plurality of frequency characteristics acquired by the acquisition unit 42 with the corresponding reference frequency characteristics, and on the basis of the comparison result, thereby determines the presence or absence of an abnormality in the machine tool 10. In this instance, in the case that the determination unit 44 determines that there is no abnormality in the machine tool 10, the diagnostic process comes to an end. On the other hand, in the case that the determination unit 44 determines that there is an abnormality in the machine tool 10, the diagnostic process transitions to step S5.

In step S5, the determination unit 44 issues a notification that there is the possibility of an abnormality occurring in the machine tool 10. For example, if the notification period has passed a predetermined period, the diagnostic process comes to an end.

### Exemplary Modifications

The above-described embodiment may be modified in the following manner.

### Exemplary Modification 1

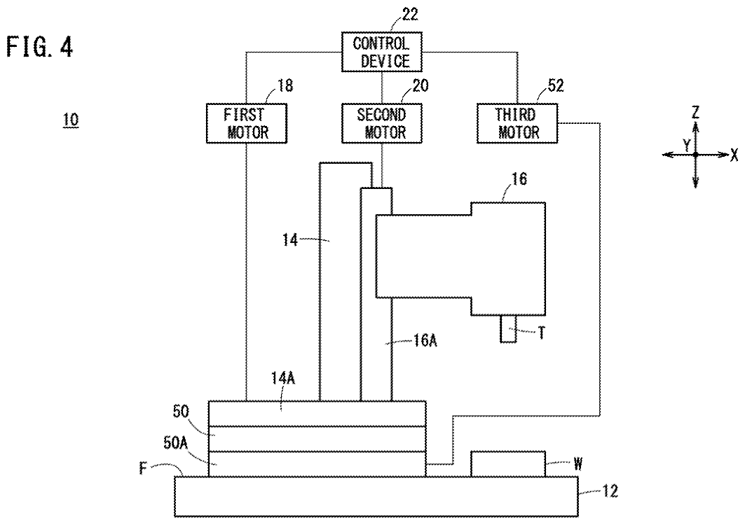

With reference to FIG. 4, a description will be given concerning the machine tool 10 according to an Exemplary Modification 1. In FIG. 4, the same reference numerals are assigned to the same constituent elements as those described in the above embodiment. Moreover, in the present exemplary modification, descriptions that overlap or are duplicative of those stated in the above-described embodiment will be omitted.

The machine tool 10 according to the Exemplary Modification 1 further includes a third movable member 50 and a third motor 52.

The third movable member 50 is capable of moving in a direction that differs from the directions in which the first movable member 14 and the second movable member 16 move. The third movable member 50 is disposed on the platform 12 via a power transmission mechanism 50A. The power transmission mechanism 50A transmits a driving force of the third motor 52 to the third movable member 50. The power transmission mechanism 50A may convert a driving force (a rotational force) of the third motor 52 into linear motion, and transmit the linear motion to the third movable member 50. Further, the power transmission mechanism 50A may transmit a driving force (a thrust force) of the third motor 52 to the third movable member 50 as it is. By the third motor 52 being driven, the third movable member 50 moves relatively in a Y-direction (third direction) with respect to the platform 12. The third motor 52 is a motor that drives the third movable member 50. Moreover, it should be noted that the third motor 52 may be a linear motor.

In the present exemplary modification, the motor control unit 40 (see FIG. 2) of the control device 22 serves to control the first motor 18, the second motor 20, and the third motor 52, in a manner so that the first movable member 14, the second movable member 16, and the third movable member 50 move under predetermined movement conditions to each of a plurality of attitude positions. Each of the plurality of attitude positions is a position determined by the position information of the first movable member 14, the position information of the second movable member 16, and the position information of the third movable member 50. The position information is stored beforehand in the storage unit 30. The movement conditions may include a movement speed and a movement direction as in the above-described embodiment. Condition information indicating the movement conditions is stored in the storage unit 30.

According to the present exemplary modification, the acquisition unit 42 (see FIG. 2) of the control device 22 acquires the frequency characteristic of each of the first motor 18, the second motor 20, and the third motor 52 including cases in which the first movable member 14, the second movable member 16, and the third movable member 50 are positioned in each of the plurality of attitude positions.

According to the present exemplary modification, the plurality of reference frequency characteristics are frequency characteristics of the first motor 18, frequency characteristics of the second motor 20, and frequency characteristics of the third motor 52, including times when the first movable member 14, the second movable member 16, and the third movable member 50 are positioned in each of the plurality attitude positions under the predetermined movement conditions. As noted previously, the reference frequency characteristics may be measured characteristics measured at a time when the machine tool 10 is assembled on site, or may be calculated characteristics that are calculated using a simulator.

According to the present exemplary modification, in the same manner as in the case of the above-described embodiment, the determination unit 44 (see FIG. 2) compares each of the plurality of frequency characteristics acquired by the acquisition unit 42 with the corresponding reference frequency characteristics, and on the basis of the comparison result, thereby determines the presence or absence of an abnormality in the machine tool 10. Accordingly, it is possible to determine the presence or absence of an abnormality in the machine tool 10, based on changes in the frequency characteristics in accordance with the relative positions of the first movable member 14, the second movable member 16, and the third movable member 50.

### Exemplary Modification 2

In the above-described embodiment, the first movable member 14 and the second movable member 16 are employed as the movable members. Further, in the above-described Exemplary Modification 1, the first movable member 14, the second movable member 16, and the third movable member 50 are employed as the movable members. However, the number of the movable members may be greater than or equal to four. Further, the configuration (the axial configuration) of the first movable member 14, the second movable member 16, and the third movable member 50 can take various forms.

### Inventions Capable of Being Grasped from the Above-Described Embodiment

Inventions that can be grasped from the above-described embodiment and the exemplary modifications thereof will be described below.

### First Invention

The first invention is characterized by the machine tool (10) including the first movable member (14), and the second movable member (16) that is different from the first movable member. The machine tool is equipped with the motor control unit (40) that controls the first motor (18) that drives the first movable member and the second motor (20) that drives the second movable member, in a manner so that the first movable member and the second movable member move under predetermined movement conditions to each of a plurality of attitude positions determined by the position information of the first movable member and the position information of the second movable member, the acquisition unit (42) that acquires the frequency characteristics of at least one of the first motor and the second motor including times when the first movable member and the second movable member are positioned in each of the plurality of attitude positions, the storage unit (30) that stores the reference frequency characteristics with respect to each of the frequency characteristics acquired by the acquisition unit, and the determination unit (44) that compares each of the frequency characteristics acquired by the acquisition unit with the corresponding reference frequency characteristics, and determines whether or not an abnormality has occurred in the machine tool based on a result of the comparison.

In accordance with such features, the presence or absence of an abnormality in the machine tool can be determined based on a change in the frequency characteristics in accordance with the relative positions of the first movable member and the second movable member, and thus, as compared to the case of simply capturing the frequency characteristics of a single feed axis, an improvement in the reliability of diagnosing an abnormality can be realized.

The acquisition unit may acquire the frequency characteristics of a motor that drives at least one of the first movable member and the second movable member, at times when at least one of the first movable member and the second movable member is moving forward or rearward including the attitude positions. In accordance with this feature, the frequency characteristics can be acquired by reducing vibrational components caused due to backlash, and the frequency characteristics including frictional components at times when the first movable member and the second movable member are moving can be acquired.

The acquisition unit may acquire the frequency characteristics of each of the first motor and the second motor at times when the first movable member and the second movable member stay still at the attitude positions.

In the case that at least one of the acquired plurality of frequency characteristics is designated as a reference, the acquisition unit may store the designated frequency characteristics in the storage unit as the reference frequency characteristics. In accordance with this feature, from among the frequency characteristics that are actually acquired, ones that are suitable as a reference can be stored as the reference frequency characteristics.

On the basis of the comparison result, the determination unit may estimate a location having a possibility of an abnormality occurring. In accordance with this feature, the abnormality in the machine tool can be captured in detail.

### Second Invention

The second invention is characterized by the diagnostic method for diagnosing an abnormality in the machine tool (10) comprising the first movable member (14), and the second movable member (16) that is different from the first movable member. The diagnostic method includes the motor control step (step S1) of controlling the first motor configured to drive the first movable member and the second motor (20) configured to drive the second movable member, in a manner so that the first movable member and the second movable member move under predetermined movement conditions to each of a plurality of attitude positions determined by the position information of the first movable member and the position information of the second movable member, the acquisition step (step S2) of acquiring the frequency characteristics of at least one of the first motor and the second motor including times when the first movable member and the second movable member are positioned in each of the plurality of attitude positions, and the determination step (step S4) of comparing each of the frequency characteristics acquired in the acquisition step with the corresponding reference frequency characteristics, and determining whether or not an abnormality has occurred in the machine tool based on a result of the comparison.

In accordance with such features, the presence or absence of an abnormality in the machine tool can be determined based on a change in the frequency characteristics in accordance with the relative positions of the first movable member and the second movable member, and thus, as compared to the case of simply capturing the frequency characteristics of a single feed axis, an improvement in the reliability of diagnosing an abnormality can be realized.

In the acquisition step, the frequency characteristics of the motor that drives at least one of the first movable member and the second movable member may be acquired, at times when at least one of the first movable member and the second movable member is moving forward or rearward including the attitude positions. In accordance with this feature, the frequency characteristics can be acquired by reducing vibrational components caused due to backlash, and the frequency characteristics including frictional components at times when the first movable member and the second movable member are moving can be acquired.

In the acquisition step, the frequency characteristics of each of the first motor and the second motor may be acquired at times when the first movable member and the second movable member that move stay still at the attitude positions.

In the acquisition step, in the case that at least one of the acquired plurality of frequency characteristics is designated as a reference, the designated frequency characteristics may be stored in the storage unit (30) as reference frequency characteristics. In accordance with this feature, from among the frequency characteristics that are actually acquired, ones that are suitable as a reference can be stored as the reference frequency characteristics.

In the determination step, on the basis of the comparison result, a location may be estimated having a possibility of the abnormality occurring. In accordance with this feature, the abnormality in the machine tool can be captured in detail.

1. A machine tool comprising a first movable member, and a second movable member that is different from the first movable member, the machine tool comprising:
a motor control unit configured to control a first motor configured to drive the first movable member and a second motor configured to drive the second movable member, in a manner so that the first movable member and the second movable member move under predetermined movement conditions to each of a plurality of attitude positions determined by position information of the first movable member and position information of the second movable member;
an acquisition unit configured to acquire frequency characteristics of at least one of the first motor and the second motor including times when the first movable member and the second movable member are positioned in each of the plurality of attitude positions;
a storage unit configured to store reference frequency characteristics with respect to each of the frequency characteristics acquired by the acquisition unit; and
a determination unit configured to compare each of the frequency characteristics acquired by the acquisition unit with corresponding reference frequency characteristics, and to determine whether or not an abnormality has occurred in the machine tool based on a result of the comparison.

2. The machine tool according to claim 1, wherein the acquisition unit acquires the frequency characteristics of a motor that drives at least one of the first movable member and the second movable member, at times when at least one of the first movable member and the second movable member is moving forward or rearward including the attitude positions.

3. The machine tool according to claim 1, wherein the acquisition unit acquires the frequency characteristics of each of the first motor and the second motor at times when the first movable member and the second movable member that move stay still at the attitude positions.

4. The machine tool according to claim 1, wherein, in the case that at least one of the acquired plurality of frequency characteristics is designated as a reference, the acquisition unit stores the designated frequency characteristics in the storage unit as reference frequency characteristics.

5. The machine tool according to claim 1, wherein, on the basis of the comparison result, the determination unit estimates a location having a possibility of the abnormality occurring.

6. A diagnostic method for diagnosing an abnormality in a machine tool comprising a first movable member and a second movable member that is different from the first movable member, the diagnostic method comprising:
a motor control step of controlling a first motor configured to drive the first movable member and a second motor configured to drive the second movable member, in a manner so that the first movable member and the second movable member move under predetermined movement conditions to each of a plurality of attitude positions determined by position information of the first movable member and position information of the second movable member;
an acquisition step of acquiring frequency characteristics of at least one of the first motor and the second motor including times when the first movable member and the second movable member are positioned in each of the plurality of attitude positions;
and
a determination step of comparing each of the frequency characteristics acquired in the acquisition step with corresponding reference frequency characteristics, and determining whether or not an abnormality has occurred in the machine tool based on a result of the comparison.

7. The diagnostic method according to claim 6, wherein, in the acquisition step, the frequency characteristics of a motor that drives at least one of the first movable member and the second movable member are acquired, at times when at least one of the first movable member and the second movable member is moving forward or rearward including the attitude positions.

8. The diagnostic method according to claim 6, wherein, in the acquisition step, the frequency characteristics of each of the first motor and the second motor are acquired at times when the first movable member and the second movable member that move stay still at the attitude positions.

9. The diagnostic method according to claim 6, wherein, in the acquisition step, in the case that at least one of the acquired plurality of frequency characteristics is designated as a reference, the designated frequency characteristics are stored in the storage unit as reference frequency characteristics.

10. The diagnostic method according to claim 6, wherein, in the determination step, on the basis of the comparison result, a location is estimated having a possibility of the abnormality occurring.
